(19) United States
(12) Patent Application Publication
(10) Pub. No.: US 2003/0167259 A1
(43) Pub. Date: Sep. 4, 2003

(54) Interactive sales and marketing network system

(76) Inventors: Mike Casson, Dallas, TX (US); Rob Weaver, Dallas, TX (US); Sam Johnson, Dallas, TX (US); Brian Boltwood, Dallas, TX (US)

Correspondence Address: HAYNES AND BOONE, LLP, 901 MAIN STREET, SUITE 3100, DALLAS, TX, 75202, US

(21) Appl. No.: 09/843,087

(22) Filed: Apr. 25, 2001

Related U.S. Application Data
(60) Provisional application No. 60/200,935, filed on May 1, 2000.

(51) Int. Cl. G06F 17/30; G06F 17/60

(52) U.S. Cl. 707/3; 707/10; 705/52; 707/102; 705/51; 707/5

(57) ABSTRACT

An interactive sales and marketing network. The network includes a common database that can be accessed by a plurality of websites. Users of the websites can search for database records within the common database. The users can then purchase the retrieved database records.

### CROSS REFERENCE TO RELATED APPLICATIONS

This application claims the benefit of the filing date of U.S. provisional patent application serial No. 60/200,935, attorney docket number 28107.15, filed on May 1, 2000, the disclosure of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### COMPUTER PROGRAM LISTING APPENDIX (37 C.F.R. §1.96(c))

This application contains a Computer Program Listing Appendix consisting of Appendix A—Software Requirements Specification created on Apr. 23, 2001, file size of 2.22 MB, Appendix B—Design Specification created on Apr. 23, 2001, file size of 1.92 MB, and Appendix C—Typical Screen Shots created on Apr. 23, 2001, file size of 3.97 MB recorded on a CD-ROM.

### BACKGROUND

This invention relates generally to interactive computer networks, and in particular to interactive computer networks for accessing databases.

Interactive computer networks for accessing marketing databases typically include a single point-of-access, such as an Internet website, that permits users of the network to access and query one or more marketing lists. The marketing lists are typically customized listings that include information such as, for example, household/business addresses, household/business incomes, household/business net worth, and household/business product preferences. Such conventional networks suffer from a number of limitations. For example, the information desired by the users of the network varies widely as a function of particular user's preferences. For example, direct mail marketers and stock brokers executing telemarketing plans will typically desire different types of information that is also presented in entirely different formats. In order for a single website to accommodate such a wide range of user needs, it must be extremely complex. As a result, conventional single point-of-access interactive networks for accessing marketing databases are typically not very user friendly. Moreover, typical interactive computer networks for accessing marketing databases include a plurality of individual, and often overlapping, marketing lists. Consequently, the search results provided to the users of the network are often inadequate, possess multiple occurrences of the same information and are incomplete.

The present invention is directed to overcoming one or more of the limitations of existing interactive computer networks for accessing marketing databases.

### SUMMARY

According to one embodiment of the present invention, a computer implemented method of accessing a common database having database records for use in an interactive sales and marketing network system is provided that includes providing a plurality of Internet websites, coupling the Internet websites to the common database, and permitting users of the websites to search the common database for database records having a particular set of characteristics using a search query.

According to another embodiment of the invention, a computer program for use in an interactive sales and marketing network system having a common database is provided that includes a computer-readable storage medium and instructions stored in the storage medium for providing a plurality of Internet websites, permitting users of the websites to access the common database, and permitting the users to search the common database for database records having a particular set of characteristics using a search query.

According to another embodiment of the invention, an interactive sales and marketing network system is provided that includes a common database including database records, a host computer coupled to the common database, and a plurality of Internet websites coupled to the common database and the host computer. The host computer is adapted to permit users of the Internet websites to search the common database for database records having a particular set of characteristics using a search query.

According to another embodiment of the invention, a computer implemented method of generating a database from one or more raw data files having data records is provided that includes importing the data records, merging the data records, removing noncompliant data records, removing duplicate data records, formatting the data records, indexing the data records, and profiling the data records.

According to another embodiment of the invention, a computer program for generating a database from one or more raw data files having data records for use in an interactive sales and marketing network system having a common database is provided that includes a computer-readable storage medium and instructions stored in the storage medium for importing the data records, merging the data records, removing noncompliant data records, removing duplicate data records, formatting the data records, indexing the data records, and profiling the data records.

According to another embodiment of the invention, a computer implemented method of operating an interactive sales and marketing system in which a user of the system can search for, retrieve, and purchase database records is provided that includes preventing the retrieval of database records that were previously purchased by the user.

According to another embodiment of the invention, a computer program for operating an interactive sales and marketing network system having a common database in which a user of the system can search for, retrieve, and purchase database records is provided that includes a computer-readable storage medium and instructions stored in the storage medium for preventing the retrieval of database records that were previously purchased by the user.

The present embodiments of the invention provide an interactive sales and marketing network in which a plurality of websites permit user to search for database records in a database that can be accessed using any one of the websites. In this manner, a common and uniform database can be accessed and searched using a plurality of websites having different graphical user interfaces that are each tailored for use by a different audience. The system further automatically generates search queries for users as a function of the user profile thereby facilitating and optimizing the search for meaningful and useful data. In addition, the system maintains a record of which database records have been purchased by a particular user and then optionally suppresses the repurchase of those records by the user. In this manner, the user is not forced to repurchase database records that were already previously purchased thereby saving the user money. Furthermore, the system permits the purchased database records to be formatted and transmitted to the user, the system, or a third party for further processing. In addition, the system also provides usage and consumer response information for search queries and tables of purchased database records thereby providing users with a measure of the probable value of their search results. Finally, the system also profiles the database of records in order to provide the user with an indication of the number of records that share a particular set of characteristics thereby further facilitating the intelligent selection and search for database records. Thus, the present embodiments of the invention provide an interactive sales and marketing network system having significantly enhanced operational features.

### BRIEF DESCRIPTION OF THE DRAWINGS

FIG. 1 is a schematic illustration of an embodiment of an interactive sales and marketing network system.

FIG. 2a is a flow chart illustration of an embodiment of a user interaction with the system of FIG. 1.

FIG. 2b is a flow chart illustration of an embodiment of a user interaction with the system of FIG. 1.

FIG. 2c is a flow chart illustration of an embodiment of a user interaction with the system of FIG. 1.

FIG. 3 is a schematic illustration of an embodiment of a table of database records.

FIG. 4 is a schematic illustration of an embodiment of a user profile.

FIG. 5 is a schematic illustration of an embodiment of a consumer response database.

FIG. 6 is a schematic illustration of an embodiment of an adaptive lookup table.

FIG. 7 is a schematic illustration of an embodiment of a usage and consumer response database included in the system of FIG. 1.

FIG. 8 is a schematic illustration of an embodiment of the applications included in the system of FIG. 1.

FIG. 9 is a schematic illustration of an embodiment of database records having user suppression codes.

FIG. 9a is a schematic illustration of an index table having user suppression codes corresponding the indexed database records.

FIG. 10 is a flow chart illustration of an embodiment of a user suppression code maintenance program.

FIG. 10a is a flow chart illustration of an embodiment of a user suppression code index table maintenance program.

FIG. 11 is a flow chart illustration of a database generation program.

FIG. 12 is a schematic illustration of an embodiment a collection of raw data files.

FIG. 13 is a schematic illustration of an embodiment of an index table.

FIG. 14 is a schematic illustration of an embodiment of a database record profile table.

### DESCRIPTION OF THE PREFERRED EMBODIMENTS

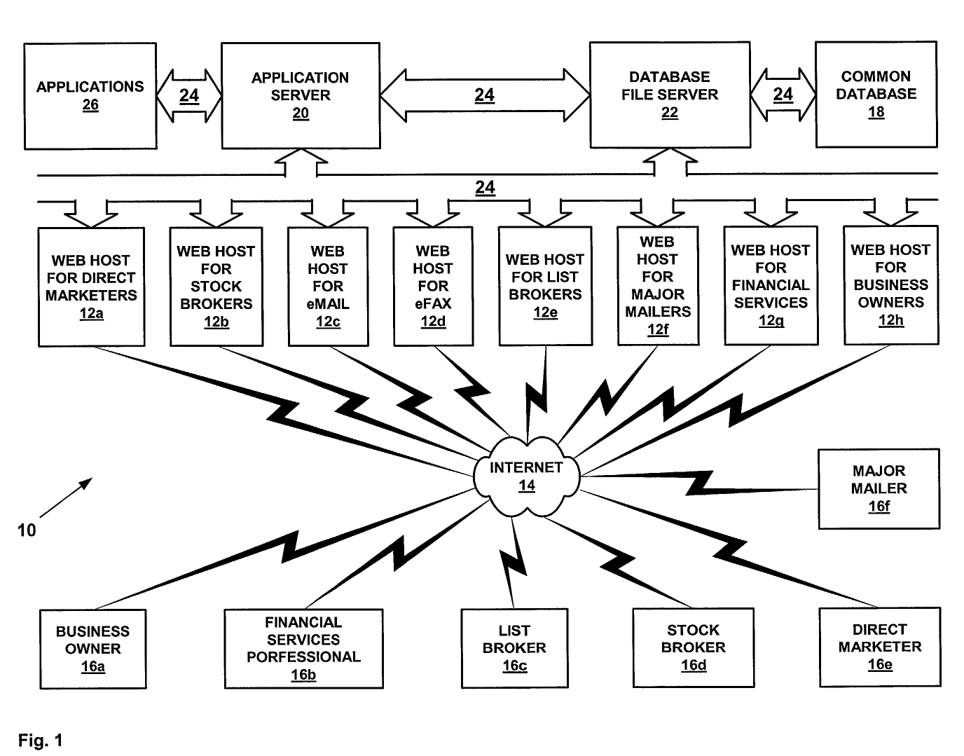

Referring to FIG. 1 of the drawings, the reference numeral 10 refers, in general, to an interactive sales and marketing network system according to an embodiment of the invention that includes a plurality of websites 12a-12h accessible using the Internet 14 that permit a plurality of users 16a-16f to search for data records in a common database 18.

Each website 12a-12h includes a unique user interface and website navigation architecture that is tailored to a particular group of users. In an exemplary embodiment, the system 10 includes a website for direct marketers 12a, a website for stock brokers 12b, a website for e-mail 12c, a website for e-fax 12d, a website for list brokers 12e, a website for major mailers 12f, a website for financial services 12g, and a website for business owners 12h. In this manner, a plurality of websites 12a-12h are provided that are specifically tailored to serve a particular category of user. Thus, in an exemplary embodiment, the users of the system 10 may include a business owner 16a, a financial services professional 16b, a list broker 16c, a stock broker 16d, a direct marketer 16e, and a major mailer 16f. As will be recognized by persons having ordinary skill in the art, the users 16a-16f of the system 10 may access the websites 12a-12h by using, for example, a personal computer, a web appliance or other Internet access device, an Internet service provider and a web browser.

The websites 12a-12h are operably coupled to an application server 20 and a database file server 22 by a conventional communications interface 24. The applications server 20 manages and controls the operation of a number of applications 26 and the database file server 22 manages and controls the operation of the common database 18 as will be described below. The general theory of operation of the application server 20 and the database file server 22 are considered well known to persons having ordinary skill in the art.

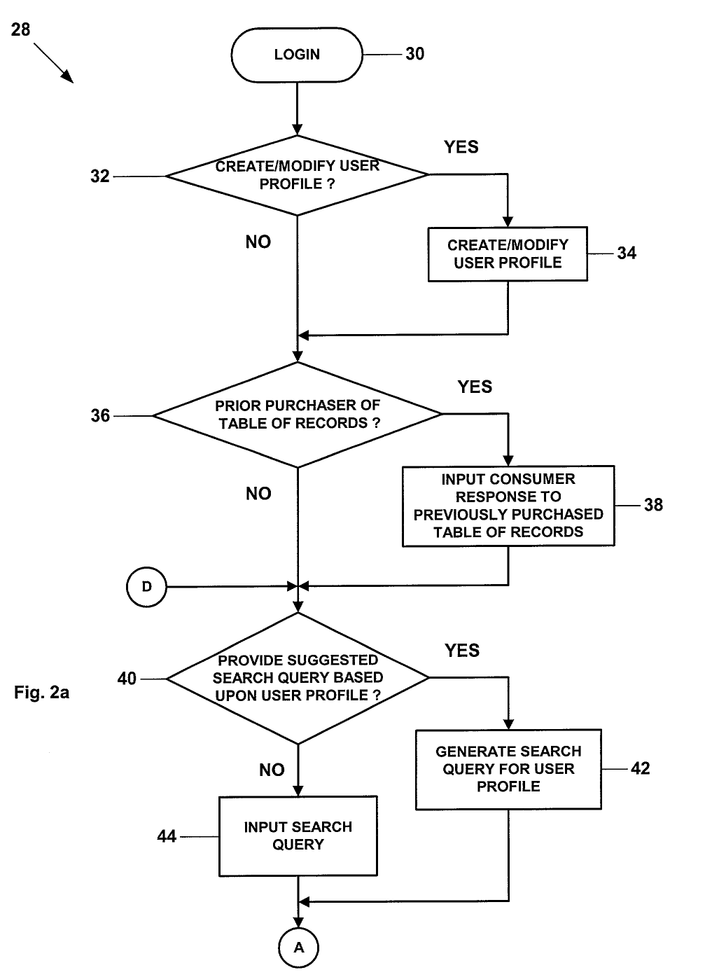

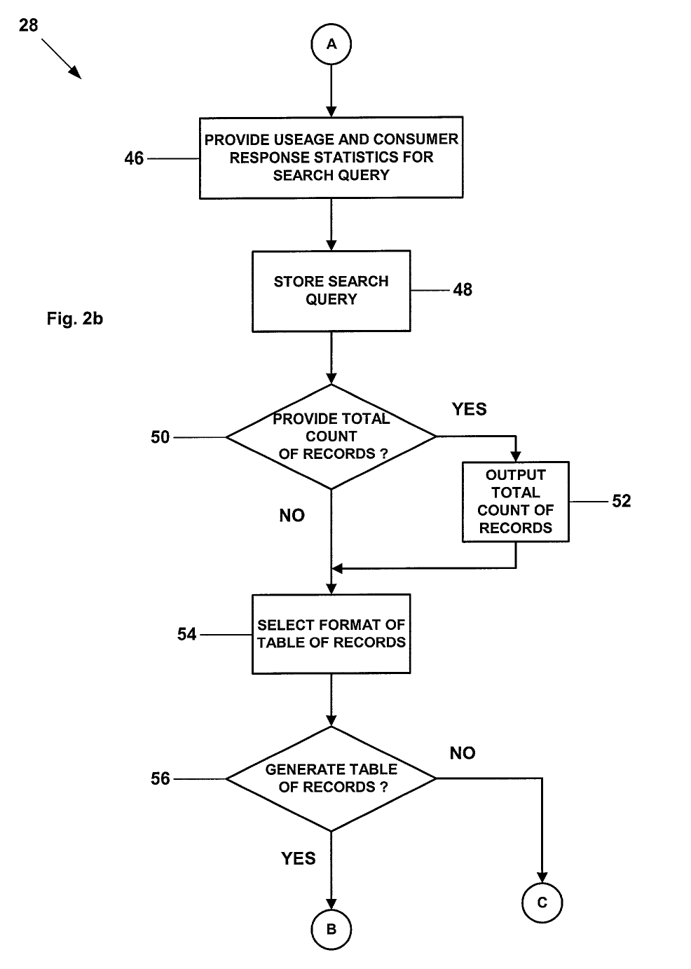

Referring to FIGS. 2a, 2b, 2c, 3, 4, 5, 6, 7, and 8, during operation of the system 10, a user 16 may interact with one of the websites 12 using a user access program 28 implemented by the websites 12 and the applications server 20 that permits the user 16 to search the common database 18 and purchase one or more database records 29. The user 16 may then use the information contained within the database records 29 to implement, for example, a marketing and sales campaign. In an exemplary embodiment, as illustrated in FIG. 3, the common database 18 includes database records 29 that include the first name, last name, city of residence, state of residence, and annual income for a number of potential consumers.

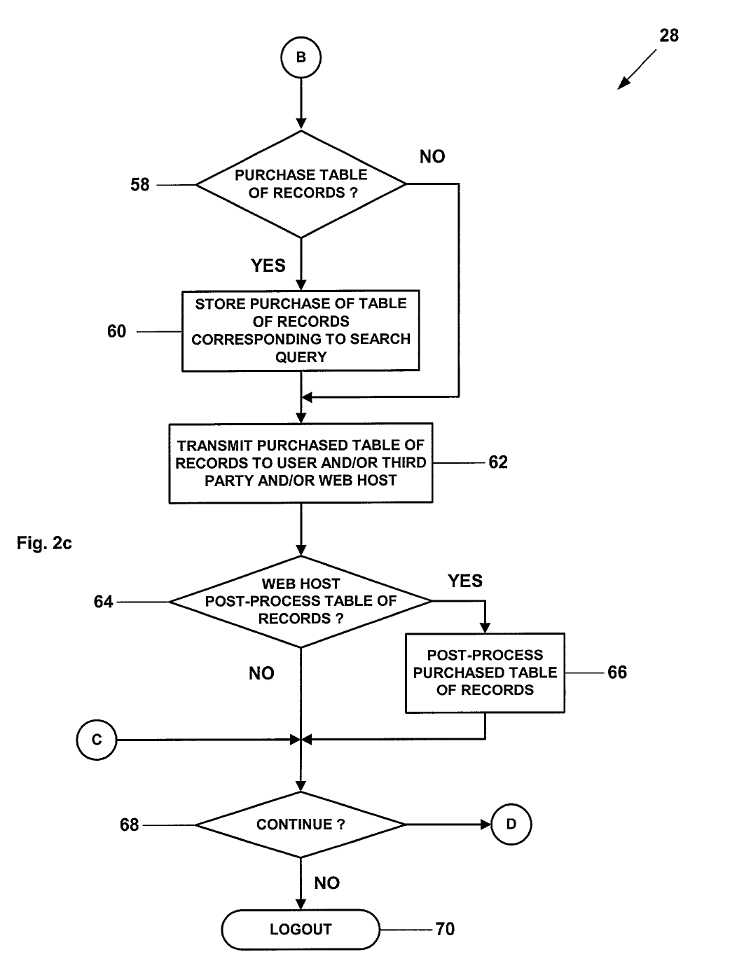

Initially, the user 16 may log onto the website 12 in step 30 by providing a unique user name and password for the selected website 12. The user 16 may then create and/or modify a user profile 33 in steps 32 and 34. In an exemplary embodiment, as illustrated in FIG. 4, the user profile 33 includes information such as, the user's identity, the user's industry, the size of the user's company, the annual sales of the user's company, the identities and prices of the user's products, the user's location(s), and profile information for the user's customers.

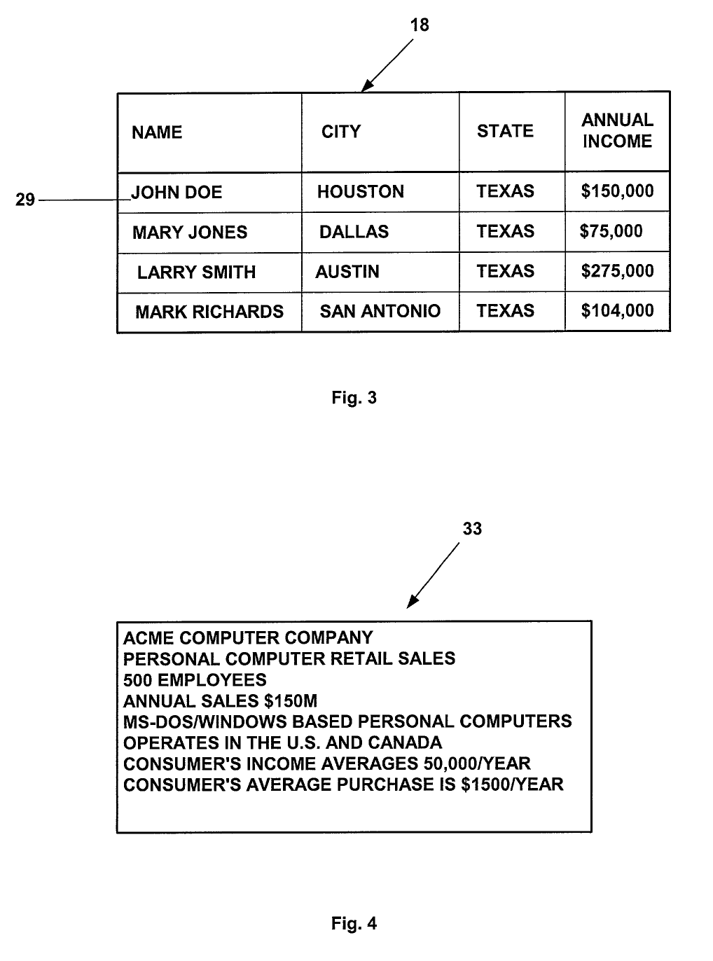

The system 10 then determines if the user 16 previously purchased database records using the system in step 36. If the user 16 previously purchased database records, the user 16 is requested to input the consumer response to the use of the database records in a marketing and sales campaign in step 38. In several exemplary embodiments, the consumer response may include the percentage response rate to a direct mailing or average amount of sales dollars generated per consumer for a previously purchased table of database records. In this manner, as illustrated in FIG. 5, the system 10 maintains a consumer response database 39 that includes the consumer response 39a to corresponding previously purchased database records 39b, as well as the particular search query 39c that resulted in the retrieval of the corresponding previously purchased database records. In this manner, the system 10 can provide consumer response information to users 16 of the system in order to optimize the economic benefits of the search process for the users.

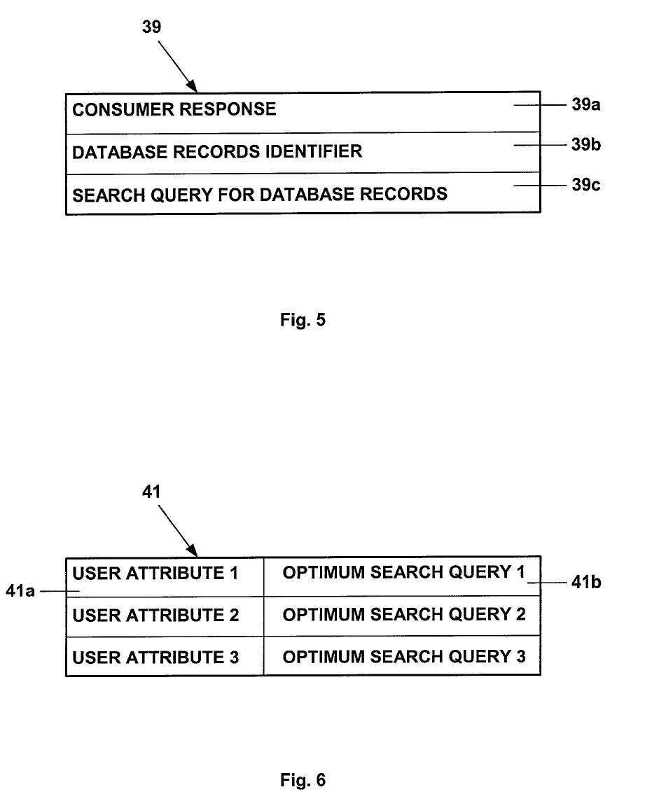

In steps 40 and 42, the system 10 offers to automatically generate a search query as a function of the user profile 33 for the user 16. In an exemplary embodiment, as illustrated in FIG. 6, the automatically generated search query is provided as a function of the user profile 33 for the user 16 by utilizing an adaptive lookup table 41 that correlates one or more user attributes 41a with search queries 41b that generated the optimum consumer response. The system 10 then selects the search query 41b that generated the greatest consumer response based upon the available user attributes 41a. In an alternative embodiment, the search query is generated by the system 10 by utilizing an expert system that supplements or substitutes for the adaptive lookup table 41.

If the user 16 does not elect to use the search query generated by the system 10, then the user 16 may enter a search query in step 44.

In an exemplary embodiment, the search query, generated by the system 10 or entered by the user 16, may include multiple inclusive and exclusive criteria in the search query. For example, the user 16 may search for data records that include businesses having (1) sales greater than $50,000 per year and (2) market value greater than $500,000, and exclude (1) businesses having zip codes in the northeast and (2) businesses that have not purchased products within the last 6 months. In this manner, the user 16 is provided with optimum flexibility and precision in selecting database records for retrieval. In an exemplary embodiment, the search query, generated by the system 10 or entered by the user 16, may also request that: (1) all of the database records are retrieved; (2) a random selection of database records are retrieved; or (3) every nth database record is retrieved in response to the search query. In this manner, the user 16 can cost effectively select database records for retrieval by selecting all, a random sampling, or every nth record.

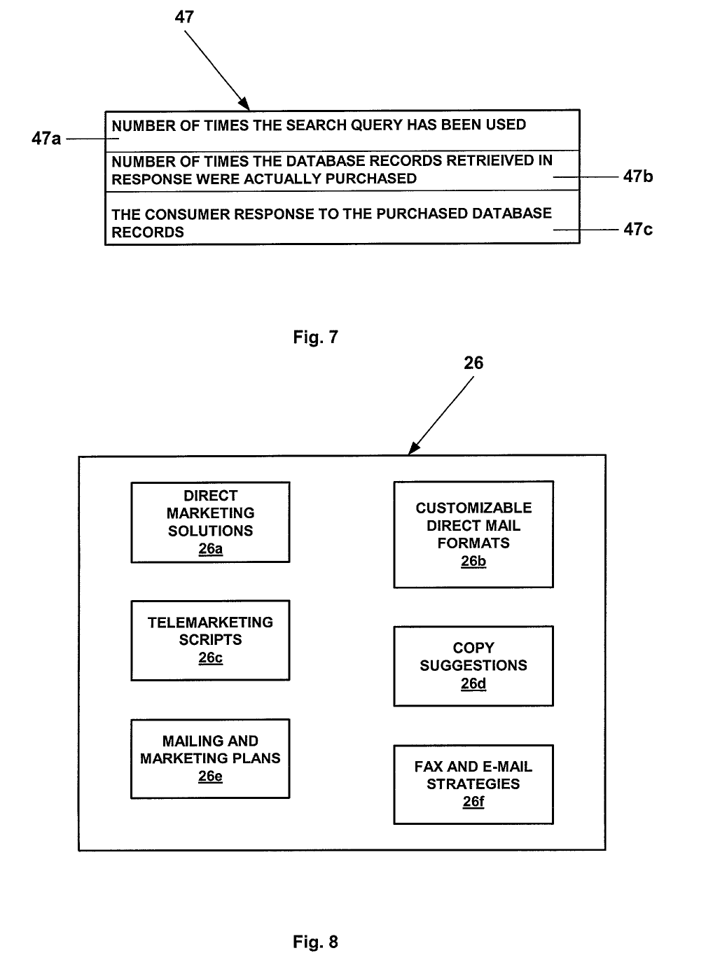

In step 46, the user 16 is provided with the usage and consumer response information 47 for the selected search query, whether entered by the user 16 or automatically generated by the system 10. In an exemplary embodiment, as illustrated in FIG. 7, the usage and consumer response information 47 includes the number of times the search query has been used 47a, the number of times the database records produced in response to the corresponding search query were actually purchased 47b, and the consumer response to the corresponding purchased database records 47c. In this manner, the user 16 can determine the potential economic benefit to be derived by using the database records that will be generated by using the selected search query.

In step 48, the selected search query is recorded by the system 10 in order to provide user statistics for users of the system. In this manner, subsequent users of the system 10 can be informed of the prior usage of the selected search query.

In steps 50 and 52, the user 16 can elect to obtain the total count of database records that are included in the table of database records that will be retrieved and generated in response to the selected search query. In this manner, the user 16 can determine the size and cost of the table of database records prior to proceeding with the actual generation and purchase of the table of database records. In several alternative embodiments, the total count of database records provided in step 52 include: (1) the total number of database records having the characteristics defined in the search query; (2) the total number of a random selection of database records having the characteristics defined in the search query; and (3) the total number of nth database records having the characteristics defined in the search query.

In step 54, the user 16 can then select the format of the table of database records that will be generated in response to the selected search query. In an exemplary embodiment, the user 16 may select a standard or default format, a custom format, or a format for a third party. The standard or default format may be selected by the user 16 or provided by the system 10. In an exemplary embodiment, the standard or default format is ASCII text or comma delimited. The custom format permits the table of database records to be further processed by the user 16 to generate a product incorporating the information included in the table of database records. In an exemplary embodiment, the custom format may be selected by the user 16 and may be ACT, EXCEL, ACCESS, TEXT, DBASE, or other database formats. The format for a third party permits the table of database records to be further processed by a third party. In an exemplary embodiment, the format for a third party may be ACT, EXCEL, ACCESS, TEXT, DBASE, or other database formats and is selected by the user 16. For example, the custom format and/or the format for a third party may permit the information included within the table of database records to be used to generate a mass mailing to a group of potential consumers.

In step 56, the user 16 can then elect to generate the table of database records in response to the selected search query.

After the generation of the table of database records in step 56, the user 16 can then elect to purchase the table of database records in step 58. The purchase of the table of database records may be provided in any conventional manner.

After the purchase of the table of database records in step 58, the system 10 records the purchase of the table of database records generated in response to the selected search query in step 60 in order to provide user statistics for users of the system. In this manner, subsequent users of the system 10 can be informed of the prior purchase of the table of database records generated in response to the selected search query. The purchased table of database records is then transmitted to the user 16 and/or a selected third party and/or the web host 12.

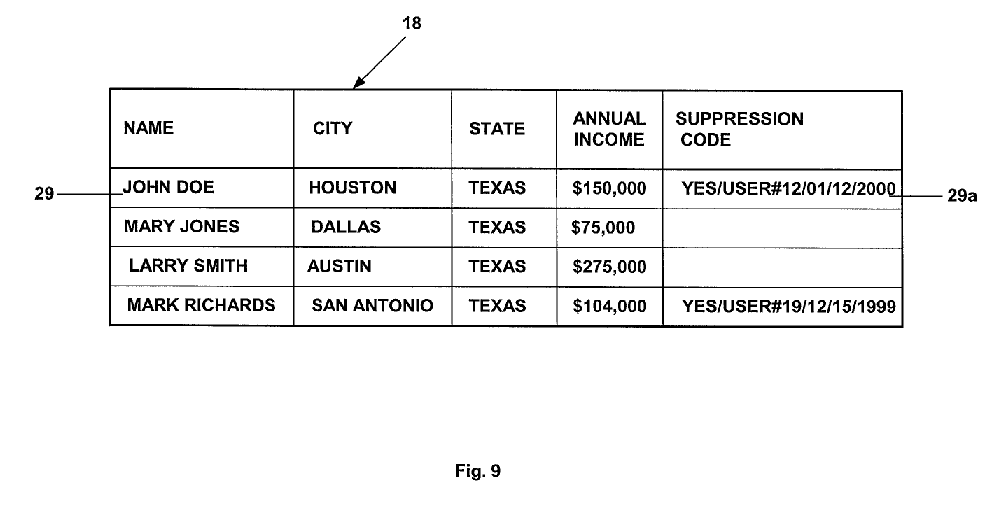

In steps 64 and 66, if the purchased table of database records was transmitted to the web host 12, then the web host 12 may process the purchased table of database records using one or more of the applications 26. In an exemplary embodiment, as illustrated in FIG. 8, the applications 26 include conventional direct marketing solutions 26a, customizable direct mail formats 26b, telemarketing scripts 26c, copy suggestions 26d, mailing and marketing plans 26e, and fax and e-mail strategies 26f. In this manner, the information contained within the database records may be processed to generate an output product.

The user 16 may then continue in step 68, or, alternatively, the user 16 may logout of the website 12.

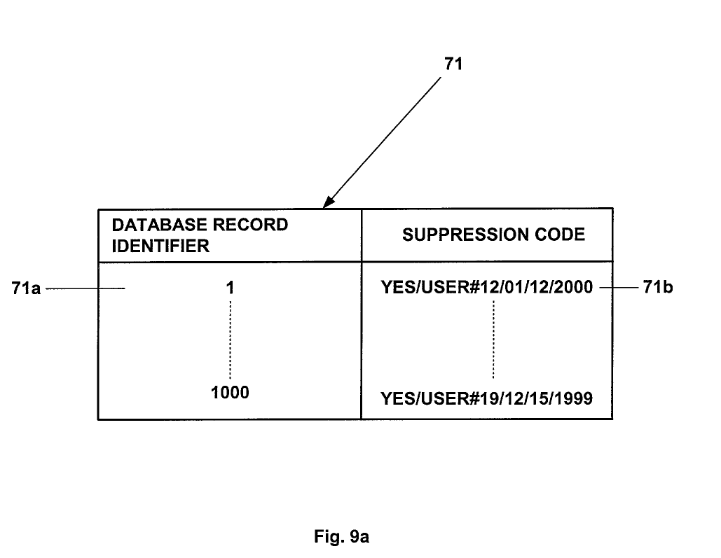

Referring to FIG. 9, during operation of the system 10, each of the database records 29 in the common database 18 further include one or more user suppression codes 29a. During operation of the system 10, when a user 16 executes a search of the common database 18 using a selected search query, the system 10 controllably suppresses the retrieval of database records 29 that include a user suppression code 29a for the particular user 16. In an exemplary embodiment, the user suppression code 29a is assigned to all database records 29 that were previously purchased by a user 16. Thus, each database record 29 may include a user suppression code 29a for each user that has previously purchased the database record 29. In an exemplary embodiment, the user suppression code 29a includes: (a) the user identification, (b) an indication of the prior purchase, and (c) the prior purchase date. In this manner, the user 16 does not have to pay for database records 29 that the user 16 previously purchased using the system 10.

Referring to FIG. 9a, in an alternative embodiment, the system 10 generates and maintains a suppression code index table 71 that includes a unique database record identifier 71a for each database record 29 and a suppression code value 71b for the indexed database record. Thus, each database record identifier 71a may include a user suppression code 71b for each user that has previously purchased the corresponding database record 29. In an exemplary embodiment, the user suppression code 71b includes: (a) the user identification, (b) an indication of the prior purchase, and (c) the prior purchase date. In this manner, the size of the database 18 including the database records 29 is minimized by reducing the overall record length of the database records 29. Furthermore, by separating the suppression codes 71b from the actual database records 29 through the use of the index table 71, the maintenance and updating of the suppression codes 71b is more efficient. In particular, decoupling the maintenance and updating of the suppression codes 71b from the database 18 eliminates time consuming processing time for maintaining and updating the suppression codes 71b from effecting the efficient usage of the database records for searches. Furthermore, the database records 29 in the database 18 can be relatively static, rather than transactional.

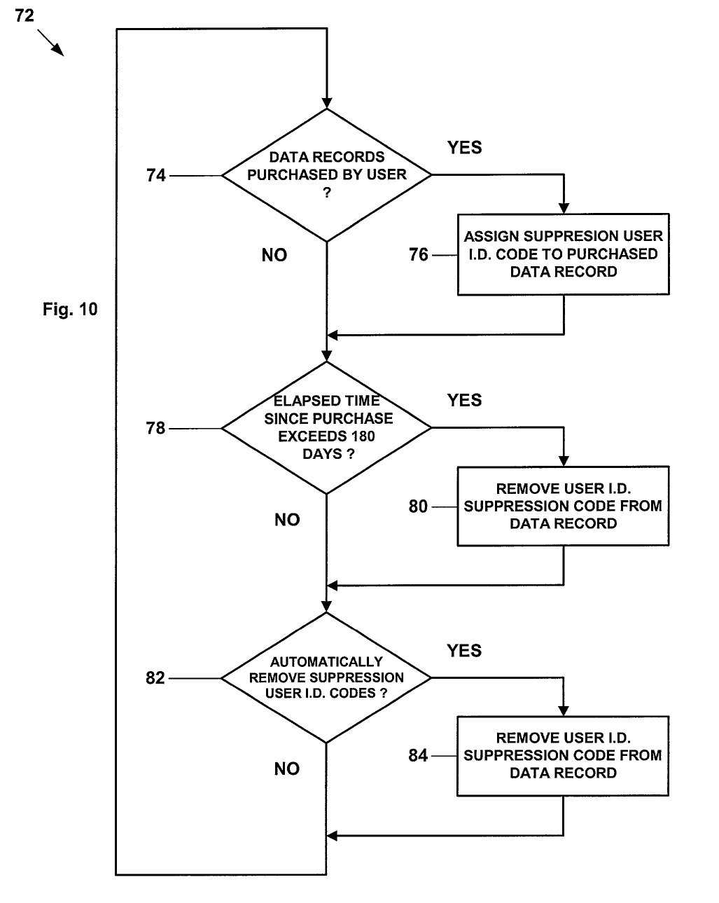

Referring to FIG. 10, the system 10 maintains and updates the user suppression codes 29a in the database records 29 of the database 18 by implementing a user suppression code maintenance program 72 that monitors the operation of the system 10 and determines if a database record 29 has been purchased by a user 16 in step 74. If the database record 29 was purchased by a user 16, then the system 10 adds a user suppression code 29a to the database record 29 that indicates that the database record 29 was purchased by the user 16 on the corresponding purchase date in step 76.

In step 78, the system 10 reviews the database records 29 in the common database 18 to determine how long it has been since the database records 29 having user suppression codes 29a were purchased. If a predetermined time period has elapsed since the database records 29 having user suppression codes 29a were purchased by a particular user 16, then the system 10 removes the user suppression code 29a for the particular user 16 from the database record 29 in step 80. In this manner, the particular user 16 may again purchase the database record 29 using the system 10. In an exemplary embodiment, the user suppression code 29a is removed if more than 180 days has elapsed since the last purchase of the database record 29 by a particular user 16. In an exemplary embodiment, the elapsed time utilized in step 78 is maintained in the user profile 33. In this manner, each user 16 may individually control the removal of the user suppression codes 29a for that user 16.

In step 82, the system 10 reviews the database records 29 in the common database 18 and removes the user suppression code 29a from all database records 29 for which a user 16 or the system 10 has selected automatic removal in the user profile 33. In this manner, a user 16 may elect to always repurchase previously purchased database records 29. If the user 16 or the system 10 has elected automatic removal of the user suppression code 29a for the user 16, then the system 10 removes the user suppression code 29a in step 84.

Referring to FIG. 10a, the system 10 maintains and updates the suppression codes 71b in the user suppression index table 71 by implementing a user suppression index table maintenance program 86 that monitors the operation of the system 10 and determines if a database record 29 has been purchased by a user 16 in step 88. If the database record 29 was purchased by a user 16, then the system 10 adds a user suppression code 71b for the corresponding database record identifier 71a in the user suppression index table 71 to indicate that the database record 29 was purchased by the user 16 on the corresponding purchase date in step 76.

In step 78, the system 10 reviews the suppression codes 71b in the suppression code index table 71 to determine how long it has been since the database record identifiers 71a having user suppression codes 71b were purchased. If a predetermined time period has elapsed since the database record identifiers 71a having user suppression codes 71b were purchased by a particular user 16, then the system 10 removes the user suppression codes 71b for the particular user 16 from the suppression code index table 71 in step 80. In this manner, the particular user 16 may again purchase the database record 29 using the system 10. In an exemplary embodiment, the user suppression code 71b is removed from the suppression code index table 71 if more than 180 days has elapsed since the last purchase of the database record 29 by a particular user 16. In an exemplary embodiment, the elapsed time utilized in step 78 is maintained in the user profile 33. In this manner, each user 16 may individually control the removal of the user suppression codes 29a for that user 16.

In step 82, the system 10 reviews the suppression code index table 71 and removes the user suppression code 71b from all database record identifiers 71a for which a user 16 or the system 10 has selected automatic removal in the user profile 33. In this manner, a user 16 may elect to always repurchase previously purchased database records 29. If the user 16 or the system 10 has elected automatic removal of the user suppression code 71b for the user 16, then the system 10 removes the user suppression code 71b ain step 84.

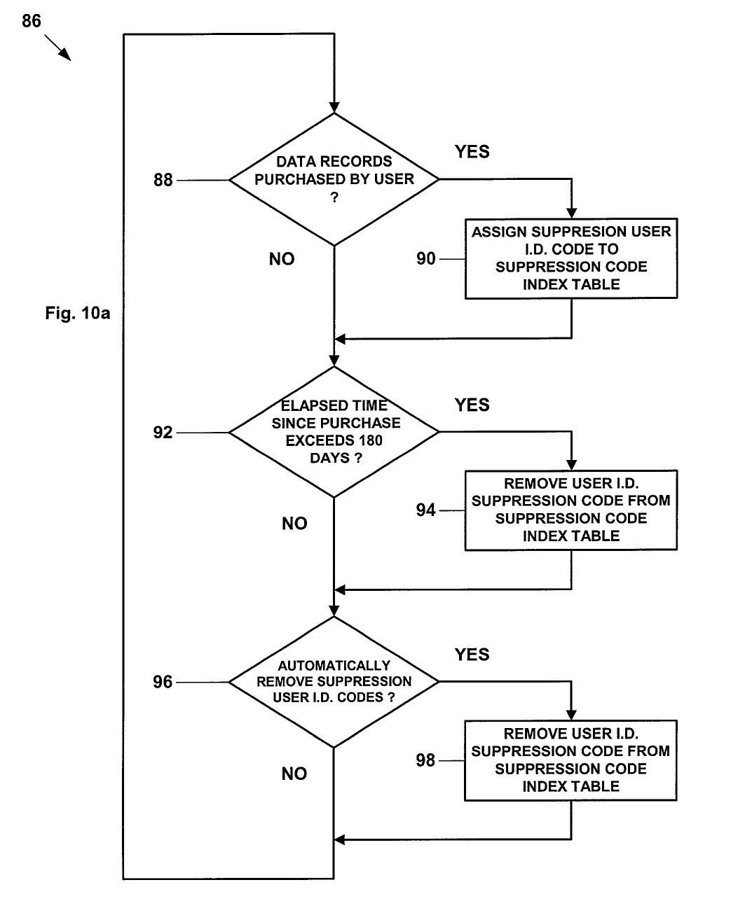

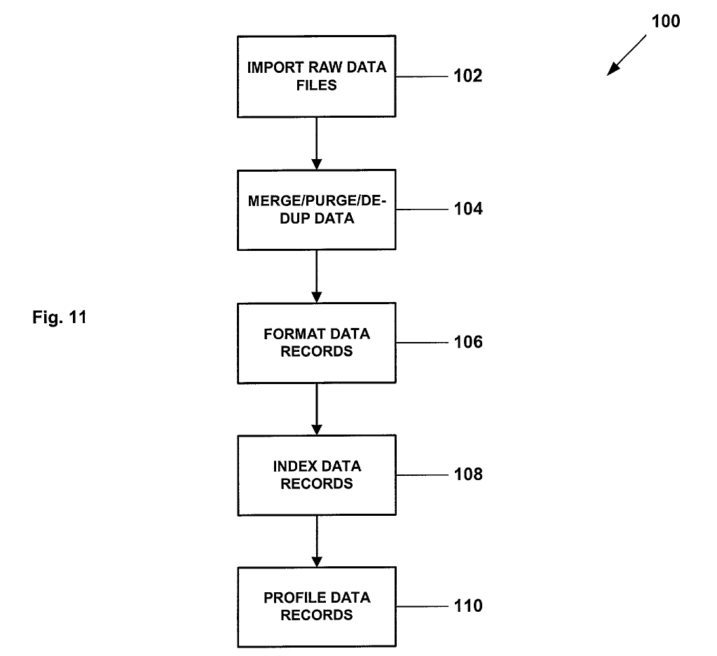

Referring to FIG. 11, the system 10 generates and analyzes the database records 29 by implementing a database record generation and analysis program 100 that imports one or more raw data files 103 including one or more data records in step 102. In an exemplary embodiment, as illustrated in FIG. 12, the raw data files 103 include an e-Fax database 103a, an e-mail database 103b, one or more compiled household database files 103c, licensed direct response data files 103d, business records 103e, specialized compiled data files 103f, and corporate data files 103g.

In step 104, the system 10 merges the raw data files 103, purges erroneous data from the merged data files, and removes duplicate data from the merged data files. In an exemplary embodiment, the merge/purge/de-dup operation of step 104 is provided in accordance with an industry standard including the step of comparing the name, address, telephone number, and zip code of the data records. The system 10 then formats the data records in step 106 by aligning the fields within the data records having same type of information, and modifying the data records to have the same overall length in a conventional manner.

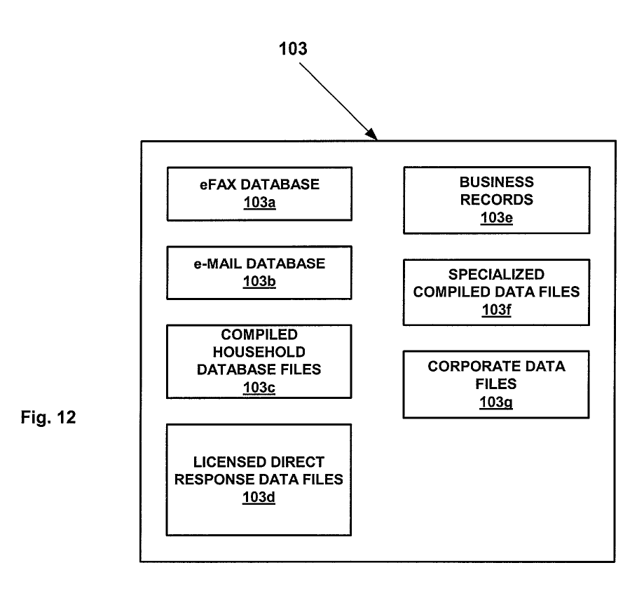

In step 108, the system 10 indexes the data records. In an exemplary embodiment, as illustrated in FIG. 13, the system 10 generates one or more index tables 109 and then modifies the data records 29 by substituting the index value 109a for the actual data field 109b in the data records 29. In this manner, the length of the data records 29 can be significantly reduced thereby conserving memory and search processing time. In an exemplary embodiment, the system 10 further assigns the database record identifier 71a to each data record 29 and creates a database containing the identification of all data records having a particular index value. In this manner, the search processing time can be further reduced.

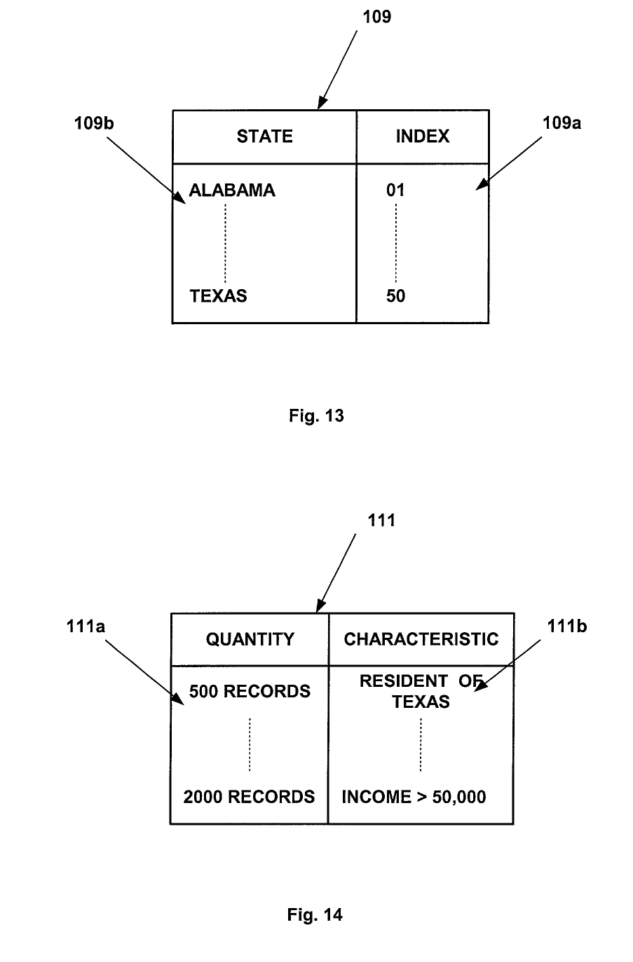

In step 110, the system 10 profiles the data records 29. In an exemplary embodiment, as illustrated in FIG. 14, the system 10 profiles the data records 29 by creating one or more data profile tables 111 that record the number of data records 111a having one or more particular characteristics 111b. In this manner, the user 16 can quickly determine the quantity of database records 29 having a particular set of characteristics thereby facilitating the efficient and informed purchase of the a table of database records.

In an exemplary embodiment, the design and operation of the system 10 is provided substantially as described in the Computer Program Listing Appendix to the present application.

The interactive sales and marketing network system of the present disclosure provides several advantages. For example, the interactive sales and marketing network includes a plurality of websites that permit users to search for database records in a database that can be accessed using any one of the websites. In this manner, a common and uniform database can be accessed and searched using a plurality of websites having different graphical user interfaces that are each tailored for use by a different audience. The system further automatically generates search queries for users as a function of the user profile thereby facilitating and optimizing the search for meaningful and useful data. In addition, the system maintains a record of which database records have been purchased by a particular user and then optionally suppresses the repurchase of those records by the user. In this manner, the user is not forced to repurchase database records that were already previously purchased thereby saving the user money. Furthermore, the system permits the purchased database records to be formatted and transmitted to the user, the system, or a third party for further processing. In addition, the system also provides usage and consumer response information for search queries and tables of purchased database records thereby providing users with a measure of the probable value of their search results. Finally, the system also profiles the database of records in order to provide the user with an indication of the number of records that share a particular set of characteristics thereby further facilitating the intelligent selection and search for database records.

It is understood that variations may be made in the foregoing without departing from the scope of the invention. For example, the system 10 may be adapted to provide a common database 18 that contains additional or other types of information for searching and retrieval. For example, the system 10 could be adapted to provide travel, hotel and rental car information by utilizing a common database of travel information that can be accessed by a air travel website, a hotel website, and a rental car website thereby providing an efficient and cost effective interactive system for travel that includes a plurality of individual customized websites.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. A computer implemented method of accessing a common database having database records for use in an interactive sales and marketing network system, comprising:
providing a plurality of Internet websites;
coupling the Internet websites to the common database; and
permitting users of the websites to search the common database for database records having a particular set of characteristics using a search query.

2. The method of claim 1, wherein permitting users of the websites to search the common database for database records having a particular set of characteristics using a search query includes:
permitting users of the websites to search the common database for a random selection of database records having a particular set of characteristics using the search query.

3. The method of claim 1, wherein permitting users of the websites to search the common database for database records having a particular set of characteristics using a search query includes:
permitting users of the websites to search the common database for every nth database record having a particular set of characteristics using the search query.

4. The method of claim 1, wherein the search query includes:
selecting database records having multiple inclusive and exclusive characteristics.

5. The method of claim 1, further including:
permitting the users to maintain corresponding user profiles.

6. The method of claim 5, further including:
automatically generating a search query for a user for searching the common database as a function of the corresponding user profile.

7. The method of claim 6, further comprising:
automatically generating a search query for searching the common database for a random selection of database records having a particular set of characteristics as a function of the corresponding user profile.

8. The method of claim 6, further comprising:
automatically generating a search query for searching the common database for every nth database record having a particular set of characteristics as a function of the corresponding user profile.

9. The method of claim 6, further comprising:
automatically generating a search query for searching the common database for database records having multiple inclusive and exclusive characteristics as a function of the corresponding user profile.

10. The method of claim 1, further including:
permitting users of the websites to purchase the database records having the particular set of characteristics.

11. The method of claim 10, further including:
if a user previously purchased database records, requesting the user to provide the consumer response to the previously purchased database records.

12. The method of claim 10, further including:
if the user previously purchased particular database records, then not retrieving those particular database records in response to the user search for database records having the particular set of characteristics.

13. The method of claim 10, further including:
transmitting the purchased database records to a third party.

14. The method of claim 10, further including:
transmitting the purchased database records to the system.

15. The method of claim 10, further including:
recording the purchase of the purchased database records including the corresponding search query.

16. The method of claim 10, further including:
the system processing the purchased database records to generate an output product.

17. The method of claim 1, further including:
automatically generating a search query for a user for searching the common database.

18. The method of claim 1, further including:
providing usage statistics for a search query selected for use by a user.

19. The method of claim 1, further including:
providing the consumer response statistics for a search query selected for use by a user.

20. The method of claim 1, further including:
recording a search query selected for use by a user.

21. The method of claim 1, further including:
providing the number of database records having the particular set of characteristics.

22. The method of claim 21, wherein providing the number of database records having particular set of characteristics includes:
providing a random number of database records having the particular set of characteristics.

23. The method of claim 21, wherein providing the number of database records having particular set of characteristics includes:
providing the number of nth database records having the particular set of characteristics.

24. A computer program for use in an interactive sales and marketing network system having a common database, comprising:
a computer-readable storage medium; and
instructions stored in the storage medium for the following:
providing a plurality of Internet websites;
permitting users of the websites to access the common database; and
permitting the users to search the common database for database records having a particular set of characteristics using a search query.

25. The computer program of claim 24, wherein permitting users of the websites to search the common database for database records having a particular set of characteristics using a search query includes:
permitting users of the websites to search the common database for a random selection of database records having a particular set of characteristics using the search query.

26. The computer program of claim 24, wherein permitting users of the websites to search the common database for database records having a particular set of characteristics using a search query includes:
permitting users of the websites to search the common database for every nth database record having a particular set of characteristics using the search query.

27. The computer program of claim 24, wherein the search query includes:
selecting database records having multiple inclusive and exclusive characteristics.

28. The computer program of claim 24, further including instructions stored in the storage medium for:
permitting the users to maintain corresponding user profiles.

29. The computer program of claim 28, further including instructions stored in the storage medium for:
the system automatically generating a search query for a user for searching the common database as a function of the corresponding user profile.

30. The computer program of claim 29, further including instructions stored in the storage medium for:
the system automatically generating a search query for searching the common database for a random selection of database records having a particular set of characteristics as a function of the corresponding user profile.

31. The computer program of claim 29, further including instructions stored in the storage medium for:
the system automatically generating a search query for searching the common database for every nth database record having a particular set of characteristics as a function of the corresponding user profile.

32. The computer program of claim 29, further including instructions stored in the storage medium for:
the system automatically generating a search query for searching the common database for database records having multiple inclusive and exclusive characteristics as a function of the corresponding user profile.

33. The computer program of claim 24, further including instructions stored in the storage medium for:
permitting users of the websites to purchase the database records having the particular set of characteristics.

34. The computer program of claim 33, further including instructions stored in the storage medium for:
if a user previously purchased database records, requesting the user to provide the consumer response to the previously purchased database records.

35. The computer program of claim 33, further including instructions stored in the storage medium for:
if the user previously purchased particular database records, then not retrieving those particular database records in response to the user search for database records having the particular set of characteristics.

36. The computer program of claim 33, further including instructions stored in the storage medium for:
transmitting the purchased database records to a third party.

37. The computer program of claim 33, further including instructions stored in the storage medium for:
transmitting the purchased database records to the system.

38. The computer program of claim 33, further including instructions stored in the storage medium for:
recording the purchase of the purchased database records including the corresponding search query.

39. The computer program of claim 33, further including instructions stored in the storage medium for:
the system processing the purchased database records to generate an output product.

40. The computer program of claim 24, further including:
the system automatically generating a search query for a user for searching the common database.

41. The computer program of claim 24, further including:
providing usage statistics for a search query selected for use by a user.

42. The computer program of claim 24, further including:
providing the consumer response statistics for a search query selected for use by a user.

43. The computer program of claim 24, further including:
recording a search query selected for use by a user.

44. The computer program of claim 24, further including:
providing the number of database records having the particular set of characteristics.

45. The computer program of claim 44, wherein providing the number of database records having particular set of characteristics includes:
providing a random number of database records having the particular set of characteristics.

46. The computer program of claim 44, wherein providing the number of database records having particular set of characteristics includes:
providing the number of nth database records having the particular set of characteristics.

47. An interactive sales and marketing network system, comprising:
a common database including database records;
a host computer coupled to the common database; and
a plurality of Internet websites coupled to the common database and the host computer;
wherein the host computer is adapted to permit users of the Internet websites to search the common database for database records having a particular set of characteristics using a search query.

48. The system of claim 47, wherein permitting users of the websites to search the common database for database records having a particular set of characteristics using a search query includes:
permitting users of the websites to search the common database for a random selection of database records having a particular set of characteristics using the search query.

49. The system of claim 47, wherein permitting users of the websites to search the common database for database records having a particular set of characteristics using a search query includes:
permitting users of the websites to search the common database for every nth database record having a particular set of characteristics using the search query.

50. The system of claim 47, wherein the search query includes:
selecting database records having multiple inclusive and exclusive characteristics.

51. The system of claim 47, wherein each Internet website includes a different graphical user interface.

52. The system of claim 47, wherein the host computer is further adapted to permit users to maintain corresponding user profiles.

53. The system of claim 52, wherein the host computer is further adapted to automatically generate a search query for a user for searching the common database as a function of the corresponding user profile.

54. The system of claim 53, wherein the host computer is further adapted to generate a search query for searching the common database for a random selection of database records having a particular set of characteristics as a function of the corresponding user profile.

55. The system of claim 53, wherein the host computer is further adapted to generate a search query for searching the common database for every nth database record having a particular set of characteristics as a function of the corresponding user profile.

56. The system of claim 53, wherein the system generates a search query for searching the common database for database records having multiple inclusive and exclusive characteristics.

57. The system of claim 47, wherein the host computer is further adapted to permit users of the websites to purchase the database records having the particular set of characteristics.

58. The system of claim 57, wherein the host computer is further adapted to, if a user previously purchased database records, request the user to provide the consumer response to the previously purchased database records.

59. The system of claim 57, wherein the host computer is further adapted to, if the user previously purchased particular database records, then not retrieve those particular database records in response to the user search for database records having the particular set of characteristics.

60. The system of claim 57, wherein the host computer is further adapted to transmit the purchased database records to a third party.

61. The system of claim 57, wherein the host computer is further adapted to transmit the purchased database records to the system.

62. The system of claim 57, wherein the host computer is further adapted to record the purchase of the purchased database records including the corresponding search query.

63. The system of claim 57, wherein the host computer is further adapted to process the purchased database records to generate an output product.

64. The system of claim 47, wherein the host computer is further adapted to automatically generate a search query for a user for searching the common database.

65. The system of claim 47, wherein the host computer is further adapted to provide usage statistics for a search query selected for use by a user.

66. The system of claim 47, wherein the host computer is further adapted to provide the consumer response statistics for a search query selected for use by a user.

67. The system of claim 47, wherein the host computer is further adapted to record a search query selected for use by a user.

68. The system of claim 47, wherein the host computer is further adapted to provide the number of database records having the particular set of characteristics.

69. The system of claim 68, wherein providing the number of database records having particular set of characteristics includes:
providing a random number of database records having the particular set of characteristics.

70. The system of claim 68, wherein providing the number of database records having particular set of characteristics includes:
providing the number of nth database records having the particular set of characteristics.

71. A computer implemented method of generating a database from one or more raw data files having data records, comprising:
importing the data records;
merging the data records;
removing noncompliant data records;
removing duplicate data records;
formatting the data records;
indexing the data records; and
profiling the data records.

72. The method of claim 71, wherein the data records include one or more data fields containing corresponding data; and wherein indexing the data records includes:
generating an index table including index values corresponding to the data; and
substituting the index values for the data in the data fields of the data records.

73. The method of claim 71, wherein profiling the data records includes:
determining how many data records share common characteristics.

74. A computer program for generating a database from one or more raw data files having data records for use in an interactive sales and marketing network system having a common database, comprising:
a computer-readable storage medium; and
instructions stored in the storage medium for the following:
importing the data records;
merging the data records;
removing noncompliant data records;
removing duplicate data records;
formatting the data records;
indexing the data records; and
profiling the data records.

75. The computer program of claim 74, wherein the data records include one or more data fields containing corresponding data; and wherein indexing the data records includes:
generating an index table including index values corresponding to the data; and
substituting the index values for the data in the data fields of the data records.

76. The computer program of claim 74, wherein profiling the data records includes:
determining how many data records share common characteristics.

77. A system for generating a database from one or more raw data files having data records for use in an interactive sales and marketing network system, comprising:
a common database including database records;
a host computer coupled to the common database; and
a plurality of Internet websites coupled to the common database and the host computer;
wherein the host computer is adapted to:
import the data records;
merge the data records;
remove noncompliant data records;
remove duplicate data records;
format the data records;
index the data records; and
profile the data records.

78. The system of claim 77, wherein the data records include one or more data fields containing corresponding data; and wherein the host computer is adapted to index the data records by:
generating an index table including index values corresponding to the data; and
substituting the index values for the data in the data fields of the data records.

79. The system of claim 77, wherein the host computer is adapted to profile the data records by:
determining how many data records share common characteristics.

80. A computer implemented method of operating an interactive sales and marketing system in which a user of the system can search for, retrieve, and purchase database records, comprising:
preventing the retrieval of database records that were previously purchased by the user.

81. The method of claim 80, further including:
permitting the retrieval of database records that were previously purchased after a predetermined time period.

82. The method of claim 80, further including:
identifying database records that were previously purchased by a particular user by adding a suppression code to the database records previously purchased by the particular user.

83. The method of claim 82, wherein the suppression code includes an indication of the user identity.

84. The method of claim 82, wherein the suppression code includes an indication of the date purchased.

85. The method of claim 82, wherein the suppression codes for database records purchased more than a predetermined time period ago are removed from the database records.

86. The method of claim 80, further including:
generating an index table including database record identifiers that correspond to database records; and
identifying database records that were previously purchased by a particular user by appending a suppression code to the database record identifier in the index table that corresponds to the database records previously purchased by the particular user.

87. The method of claim 86, wherein the suppression code includes an indication of the user identity.

88. The method of claim 86, wherein the suppression code includes an indication of the date purchased.

89. The method of claim 86, wherein the suppression codes for database records purchased more than a predetermined time period ago are removed from the index table.

90. A computer program for operating an interactive sales and marketing network system having a common database in which a user of the system can search for, retrieve, and purchase database records, comprising:
a computer-readable storage medium; and
instructions stored in the storage medium for the following:
preventing the retrieval of database records that were previously purchased by the user.

91. The computer program of claim 90, further including instructions stored in the storage medium for:
permitting the retrieval of database records that were previously purchased after a predetermined time period.

92. The computer program of claim 90, further including instructions stored in the storage medium for:
identifying database records that were previously purchased by a particular user by adding a suppression code to the database records previously purchased by the particular user.

93. The computer program of claim 92, wherein the suppression code includes an indication of the user identity.

94. The computer program of claim 92, wherein the suppression code includes an indication of the date purchased.

95. The computer program of claim 92, wherein the suppression codes for database records purchased more than a predetermined time period ago are removed from the database records.

96. The computer program of claim 90, further including instructions stored in the storage medium for:
generating an index table including database record identifiers that correspond to database records; and
identifying database records that were previously purchased by a particular user by appending a suppression code to the database record identifier in the index table that corresponds to the database records previously purchased by the particular user.

97. The computer program of claim 96, wherein the suppression code includes an indication of the user identity.

98. The computer program of claim 96, wherein the suppression code includes an indication of the date purchased.

99. The computer program of claim 96, wherein the suppression codes for database records purchased more than a predetermined time period ago are removed from the index table.

100. An interactive sales and marketing network system having a common database in which a user of the system can search for, retrieve, and purchase database records, comprising:
a common database including database records;
a host computer coupled to the common database; and
a plurality of Internet websites coupled to the common database and the host computer;
wherein the host computer is adapted to:
prevent the retrieval of database records that were previously purchased by the user.

101. The system of claim 100, wherein the host computer is further adapted to:
permit the retrieval of database records that were previously purchased after a predetermined time period.

102. The system of claim 100, further including:
identifying database records that were previously purchased by a particular user by adding a suppression code to the database records previously purchased by the particular user.

103. The system of claim 102, wherein the suppression code includes an indication of the user identity.

104. The system of claim 102, wherein the suppression code includes an indication of the date purchased.

105. The system of claim 102, wherein the suppression codes for database records purchased more than a predetermined time period ago are removed from the database records.

106. The system of claim 100, wherein the host computer is further adapted to:
generate an index table including database record identifiers that correspond to database records; and
identify database records that were previously purchased by a particular user by appending a suppression code to the database record identifier in the index table that corresponds to the database records previously purchased by the particular user.

107. The system of claim 106, wherein the suppression code includes an indication of the user identity.

108. The system of claim 106, wherein the suppression code includes an indication of the date purchased.

109. The system of claim 106, wherein the suppression codes for database records purchased more than a predetermined time period ago are removed from the index table.

110. A computer implemented method of operating an interactive sales and marketing system in which a user of the system can search for, retrieve, and purchase database records, comprising:
maintaining an index table including database record identifiers corresponding to the database records and user suppression codes appended to those database record identifiers corresponding to previously purchased database records; and
preventing the retrieval of database records that were previously purchased by the user.

111. The method of claim 110, further including:
permitting the retrieval of database records that were previously purchased after a predetermined time period.

112. A computer program for maintaining a database of records in an interactive sales and marketing network system having a common database in which a user of the system can search for, retrieve, and purchase database records, comprising:
a computer-readable storage medium; and
instructions stored in the storage medium for the following:
preventing the retrieval of database records that were previously purchased by the user.

113. The computer program of claim 112, further including instructions stored in the storage medium for:
permitting the retrieval of database records that were previously purchased after a predetermined time period.

114. A system for maintaining a database of records in an interactive sales and marketing network system having a common database in which a user of the system can search for, retrieve, and purchase database records, comprising:
a common database including database records;
a host computer coupled to the common database; and
a plurality of Internet websites coupled to the common database and the host computer;
wherein the host computer is adapted to:
prevent the retrieval of database records that were previously purchased by the user.

115. The system of claim 114, wherein the host computer is further adapted to:
permit the retrieval of database records that were previously purchased after a predetermined time period.

116. A computer implemented method of accessing a common database having database records for use in an interactive sales and marketing network system, comprising:
providing a plurality of Internet websites;
coupling the Internet websites to the common database;
permitting users of the websites to search the common database for database records having a particular set of characteristics using a search query having multiple inclusive and exclusive characteristics;
permitting users of the websites to search the common database for a random selection of database records having a particular set of characteristics using a search query;
permitting users of the websites to search the common database for every nth database record having a particular set of characteristics using a search query;
permitting the users to maintain corresponding user profiles;
generating a search query for a user for searching the common database as a function of the corresponding user profile;
generating a search query for searching the common database for a random selection of database records having a particular set of characteristics as a function of the corresponding user profile;
generating a search query for searching the common database for every nth database record having a particular set of characteristics as a function of the corresponding user profile;
generating a search query for searching the common database for database records having multiple inclusive and exclusive characteristics as a function of the corresponding user profile;
permitting users of the websites to purchase the database records having the particular set of characteristics;
if a user previously purchased database records, requesting the user to provide the consumer response to the previously purchased database records;
if the user previously purchased particular database records, then not retrieving those particular database records in response to the user search for database records having the particular set of characteristics;
transmitting the purchased database records to a third party;
transmitting the purchased database records to the system;
recording the purchase of the purchased database records including the corresponding search query;
the system processing the purchased database records to generate an output product;
the system automatically generating a search query for a user for searching the common database;
providing usage statistics for a search query selected for use by a user;
providing the consumer response statistics for a search query selected for use by a user;
recording a search query selected for use by a user;
providing a random number of database records having the particular set of characteristics; and
providing the number of nth database records having the particular set of characteristics.

117. A computer program for use in an interactive sales and marketing network system having a common database, comprising:
a computer-readable storage medium; and
instructions stored in the storage medium for the following:
providing a plurality of Internet websites;
permitting users of the websites to access the common database; and
permitting the users to search the common database for database records having a particular set of characteristics using a search query including selecting database records having multiple inclusive and exclusive characteristics;
permitting users of the websites to search the common database for a random selection of database records having a particular set of characteristics using a search query;
permitting users of the websites to search the common database for every nth database record having a particular set of characteristics using a search query;
permitting the users to maintain corresponding user profiles; automatically generating a search query for a user for searching the common database as a function of the corresponding user profile;
automatically generating a search query for searching the common database for a random selection of database records having a particular set of characteristics as a function of the corresponding user profile;
automatically generating a search query for searching the common database for every nth database record having a particular set of characteristics;
automatically generating a search query for searching the common database for database records having multiple inclusive and exclusive characteristics;
permitting users of the websites to purchase the database records having the particular set of characteristics;
if a user previously purchased database records, requesting the user to provide the consumer response to the previously purchased database records;
if the user previously purchased particular database records, then not retrieving those particular database records in response to the user search for database records having the particular set of characteristics;
transmitting the purchased database records to a third party;
transmitting the purchased database records to the system;
recording the purchase of the purchased database records including a corresponding search query;
the system processing the purchased database records to generate an output product;
the system automatically generating a search query for a user for searching the common database;
providing usage statistics for the search query selected for use by a user;
providing the consumer response statistics for a search query selected for use by a user;
recording a search query selected for use by a user;
providing the number of database records having the particular set of characteristics;
providing a random number of database records having the particular set of characteristics; and
providing the number of nth database records having the particular set of characteristics.

118. An interactive sales and marketing network system, comprising:
a common database including database records;
a host computer coupled to the common database; and
a plurality of Internet websites coupled to the common database and the host computer;
wherein the host computer is adapted to:
permit users of the Internet websites to search the common database for database records having a particular set of characteristics using a search query including selecting database records having multiple inclusive and exclusive characteristics;
permit users of the websites to search the common database for a random selection of database records having a particular set of characteristics using a search query;
permit users of the websites to search the common database for every nth database record having a particular set of characteristics using a search query;
permit users to maintain corresponding user profiles;
automatically generate a search query for a user for searching the common database as a function of the corresponding user profile;
automatically generate a search query for searching the common database for a random selection of database records having a particular set of characteristics;
automatically generate a search query for searching the common database for every nth database record having a particular set of characteristics;
automatically generate a search query for searching the common database for database records having multiple inclusive and exclusive characteristics; and
permit users of the websites to purchase the database records having the particular set of characteristics;
if a user previously purchased database records, request the user to provide the consumer response to the previously purchased database records;
if the user previously purchased particular database records, then not retrieve those particular database records in response to the user search for database records having the particular set of characteristics;
transmit the purchased database records to a third party;
transmit the purchased database records to the system;
record the purchase of the purchased database records including the corresponding search query;
process the purchased database records to generate an output product;
automatically generate a search query for a user for searching the common database;
provide usage statistics for a search query selected for use by a user;
provide the consumer response statistics for the search query selected for use by a user;
record a search query selected for use by a user;
provide the number of database records having the particular set of characteristics;
provide a random number of database records having the particular set of characteristics; and
provide the number of nth database records having the particular set of characteristics; and
wherein each Internet website includes a different graphical user interface.

119. A computer implemented method of generating a database from one or more raw data files having data records, comprising:
importing the data records;
merging the data records;
removing noncompliant data records;
removing duplicate data records;
formatting the data records;
indexing the data records by a method comprising:
generating an index table including index values corresponding to the data; and
substituting the index values for the data in the data fields of the data records; and
profiling the data records by determining how many data records share common characteristics; and
wherein the data records include one or more data fields containing corresponding data.

120. A computer program for generating a database from one or more raw data files having data records for use in an interactive sales and marketing network system having a common database, comprising:
a computer-readable storage medium; and
instructions stored in the storage medium for the following:
importing the data records;
merging the data records;
removing noncompliant data records;
removing duplicate data records;
formatting the data records;
indexing the data records by a method comprising:
generating an index table including index values corresponding to the data; and
substituting the index values for the data in the data fields of the data records; and
profiling the data records by determining how many data records share common characteristics; and
wherein the data records include one or more data fields containing corresponding data.

121. A system for generating a database from one or more raw data files having data records for use in an interactive sales and marketing network system, comprising:
a common database including database records;
a host computer coupled to the common database; and
a plurality of Internet websites coupled to the common database and the host computer;
wherein the host computer is adapted to:
import the data records;
merge the data records;
remove noncompliant data records;
remove duplicate data records;
format the data records;
index the data records by a method comprising:
generating an index table including index values corresponding to the data; and
substituting the index values for the data in the data fields of the data records; and
profile the data records by determining how many data records share common characteristics;
wherein the data records include one or more data fields containing corresponding data.

122. A computer implemented method of operating an interactive sales and marketing system in which a user of the system can search for, retrieve, and purchase database records, comprising:
preventing the retrieval of database records that were previously purchased by the user;
permitting the retrieval of database records that were previously purchased after a predetermined time period;
identifying database records that were previously purchased by a particular user by adding a suppression code to the database records previously purchased by the particular user;
generating an index table including database record identifiers that correspond to database records; and
identifying database records that were previously purchased by a particular user by appending a suppression code to the database record identifier in the index table that corresponds to the database records previously purchased by the particular user;
wherein the suppression code includes an indication of the user identity and an indication of the date purchased;
wherein the suppression codes for database records purchased more than a predetermined time period ago are removed from the database records; and
wherein the suppression codes for database records purchased more than a predetermined time period ago are removed from the index table.

123. A computer program for operating an interactive sales and marketing network system having a common database in which a user of the system can search for, retrieve, and purchase database records, comprising:
a computer-readable storage medium; and
instructions stored in the storage medium for the following:
preventing the retrieval of database records that were previously purchased by the user;
permitting the retrieval of database records that were previously purchased after a predetermined time period;
identifying database records that were previously purchased by a particular user by adding a suppression code to the database records previously purchased by the particular user;
generating an index table including database record identifiers that correspond to database records; and
identifying database records that were previously purchased by a particular user by appending a suppression code to the database record identifier in the index table that corresponds to the database records previously purchased by the particular user;
wherein the suppression code includes an indication of the user identity and an indication of the date purchased; and
wherein the suppression codes for database records purchased more than a predetermined time period ago are removed from the database records; and
wherein the suppression codes for database records purchased more than a predetermined time period ago are removed from the index table.

124. An interactive sales and marketing network system having a common database in which a user of the system can search for, retrieve, and purchase database records, comprising:
a common database including database records;
a host computer coupled to the common database; and
a plurality of Internet websites coupled to the common database and the host computer;
wherein the host computer is adapted to:
prevent the retrieval of database records that were previously purchased by the user;
permit the retrieval of database records that were previously purchased after a predetermined time period;
identify database records that were previously purchased by a particular user by adding a suppression code to the database records previously purchased by the particular user;
generate an index table including database record identifiers that correspond to database records; and
identify database records that were previously purchased by a particular user by appending a suppression code to the database record identifier in the index table that corresponds to the database records previously purchased by the particular user;
wherein the suppression code includes an indication of the user identity and an indication of the date purchased;
wherein the suppression codes for database records purchased more than a predetermined time period ago are removed from the database records; and
wherein the suppression codes for database records purchased more than a predetermined time period ago are removed from the index table.

125. A computer implemented method of operating an interactive sales and marketing system in which a user of the system can search for, retrieve, and purchase database records, comprising:
maintaining an index table including database record identifiers corresponding to the database records and user suppression codes appended to those database record identifiers corresponding to previously purchased database records;
preventing the retrieval of database records that were previously purchased by the user; and
permitting the retrieval of database records that were previously purchased after a predetermined time period.

126. A computer program for maintaining a database of records in an interactive sales and marketing network system having a common database in which a user of the system can search for, retrieve, and purchase database records, comprising:
a computer-readable storage medium; and
instructions stored in the storage medium for the following:
preventing the retrieval of database records that were previously purchased by the user; and
permitting the retrieval of database records that were previously purchased after a predetermined time period.

127. A system for maintaining a database of records in an interactive sales and marketing network system having a common database in which a user of the system can search for, retrieve, and purchase database records, comprising:
a common database including database records;
a host computer coupled to the common database; and
a plurality of Internet websites coupled to the common database and the host computer;
wherein the host computer is adapted to:
prevent the retrieval of database records that were previously purchased by the user; and
permit the retrieval of database records that were previously purchased after a predetermined time period.
